(19) United States
(12) Patent Application Publication
(10) Pub. No.: US 2009/0153939 A1
(43) Pub. Date: Jun. 18, 2009

(54) COLOR DISPLAY DEVICE

(75) Inventor: Nam-Seok ROH, Seongnam-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/171,410

(22) Filed: Jul. 11, 2008

(30) Foreign Application Priority Data
Dec. 14, 2007 (KR) 10-2007-0130693

(51) Int. Cl. G02F 1/15; G02F 1/167

(52) U.S. Cl. 359/270; 359/296

(57) ABSTRACT

The color display device according to an exemplary embodiment of the present invention includes a first substrate, a second, substrate, a color reflection layer, and a color conversion layer. The first substrate is divided into a plurality of sub-pixel regions and includes a thin film transistor having a first electrode. The second substrate faces the first substrate and includes a second electrode to form an electric field together with the first electrode. The color reflection layer is disposed between the first substrate and the second substrate to reflect incident light, and the color conversion layer is disposed on the color reflection layer. The color conversion layer is a single layer.

### CROSS-REFERENCE TO RELATED APPLICATION

This application claims priority from and the benefit of Korean Patent Application No. 10-2007-0130693, filed on Dec. 14, 2007, which is hereby incorporated by reference for all purposes as if fully set forth herein.

### BACKGROUND OF THE INVENTION

1. Field of the Invention

The present invention relates to a color display device and, more particularly, to a color display device that may have a simplified manufacturing process and reduced manufacturing costs.

2. Discussion of the Background

With the development of an information society, the importance of information display devices has increased. Information display devices include a liquid crystal display (LCD), a plasma display panel (PDP), and the like. Recently, an electronic paper (e-paper), which provides a user with a view similar to viewing a piece of paper, has attracted much attention.

The e-paper is advantageous because it has high reflectivity, a high contrast ratio, and is less dependent on viewing angle. Therefore, it may be possible to display an image with a view similar to viewing a piece of paper. Moreover, the e-paper may be manufactured as a color display device for displaying color using a color filter or color conversion layer, in addition to a black-and-white display device for displaying black and white.

A conventional color display device using a color conversion layer is advantageous in that it provides high image quality characteristics; however, since it has a structure in which cyan, magenta, and yellow color conversion layers and a transparent reflective layer are stacked, it is disadvantageous in view of cost and productivity. Moreover, when the transparency of the transparent reflection layer is not sufficiently high, it may not be possible to obtain sufficient reflectivity due to a loss of brightness caused by the stacked structure, even though a full color display is achieved by a single pixel.

### SUMMARY OF THE INVENTION

The present invention provides a color display device that may have a simplified manufacturing process and reduced manufacturing costs.

Additional features of the invention will be set forth in the description which follows, and in part will be apparent from the description, or may be learned by practice of the invention.

The present invention discloses a color display device including a first substrate, a second substrate, a color reflection layer, and a color conversion layer. The first substrate is divided into a plurality of sub-pixel regions and includes a thin film transistor having a first electrode. The second substrate faces the first substrate and includes a second electrode to form an electric field together with the first electrode. The color reflection layer is disposed between the first substrate and the second substrate to reflect incident light, and a color conversion layer is disposed on the color reflection layer. The color conversion layer is a single layer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a cross-sectional view showing a color display device according to an exemplary embodiment of the present invention.

FIG. 2 is a cross-sectional view showing a process in which the color display device according to the exemplary embodiment of the present invention displays color.

FIG. 3 and FIG. 4 are diagrams showing a process in which color is displayed when a color conversion layer includes a reverse-emulsion based electrophoretic display (REED) compound.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

Spatially relative terms, such as “beneath,” “below,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

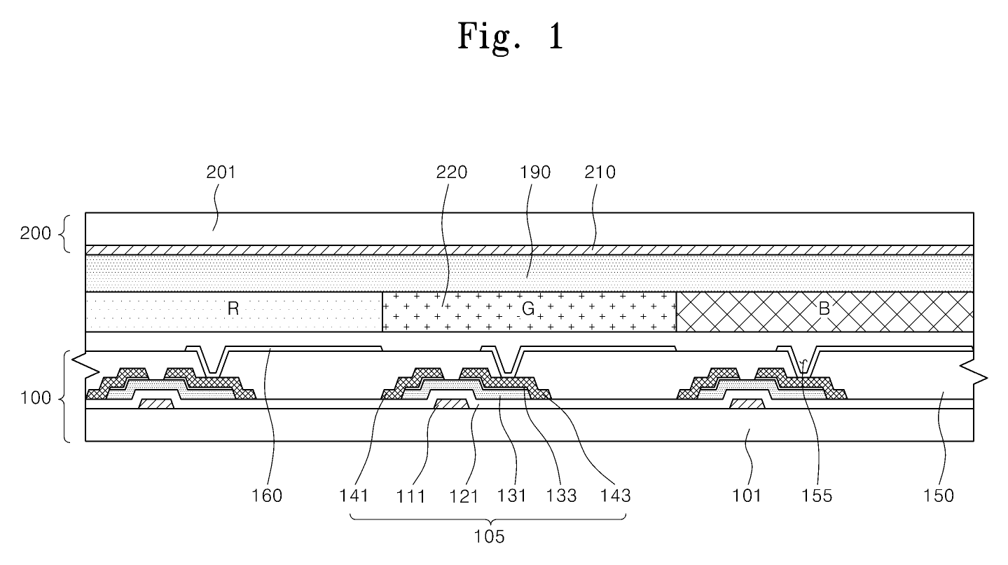

FIG. 1 is a cross-sectional view showing a color display according to an exemplary embodiment of the present invention.

Referring to FIG. 1, the color display device according to an exemplary embodiment of the present invention includes a first substrate 100, a color reflection layer 220, a color conversion layer 190, and a second substrate 200.

In particular, the first substrate 100 includes a first insulating substrate 101, a thin film transistor (TFT) 105, a passivation layer 150, and a first electrode 160.

A TFT 105 is disposed in each sub-pixel region on the first insulating substrate 101, which may be made of an insulating material, such as glass or plastic. The TFT 105 includes a gate electrode 111, a gate insulating layer 121, an active layer 131, an ohmic contact layer 133, a source electrode 141, and a drain electrode 143, disposed on the first insulating substrate 101.

The gate electrode 111 is disposed on the first insulating substrate 101 and connected to a gate line. In this case, the gate line extends in a first direction on the first insulating substrate 101. The gate insulating layer 121 may be made of an insulating material on the gate electrode 111 and on the gate line. For example, the gate insulating layer 121 may include silicon nitride (SiNₓ) or silicon oxide (SiOₓ) on the entire surface of the first substrate 100.

The active layer 131 is disposed on the gate insulating layer 121 to overlap the gate electrode 111. For example, the active layer 131 may be formed by patterning amorphous silicon on the gate insulating layer 121. Moreover, the active layer 131 may be made of polysilicon.

The ohmic contact layer 133 may include impurity-doped amorphous silicon and is disposed on the active layer 131.

The source electrode 141 is disposed on the gate insulating layer 121 and the ohmic contact layer 133 to be connected to a data line that extends in a second direction, to overlap the gate electrode 111, and to face drain electrode 143. In this case, the source electrode 141 and the drain electrode 143 may be made of the same material as the data line.

The passivation layer 150 is disposed on the gate insulating layer 121, the active layer 131, the source electrode 141, and the drain electrode 143 for the purpose of insulation and planarization. Here, the passivation layer 150 may include at least one of an inorganic passivation layer and an organic passivation layer to improve the insulation and off characteristics of the TFT 105. Moreover, the passivation layer 150 includes a contact hole 155 that exposes a portion of the drain electrode 143.

The first electrode 160 is disposed on the passivation layer 150 and connected to the drain electrode 143 of the TFT 105 through the contact hole 155. The first electrode 160 may be made of a transparent conductive material. For example, the first electrode 160 may be made of indium tin oxide (ITO), indium zinc oxide (IZO), or carbon nanotube (CNT). Here, a first electrode 160 is disposed in each sub-pixel region.

The color reflection layer 220 includes red (R), green (G), and blue (B) color reflection layers 220 to display red, green, and blue colors, respectively. In order to obtain greater brightness, the color reflection layer 220 may further include a white (W) color reflection layer 220 to display a white color.

The color reflection layer 220 may include a pigment or dye. Any suitable material may be used as the pigment or dye. In particular, the pigment may include at least one red pigment, such as bengala, vermilion, and cadmium red, at least one green pigment, such as emerald green and chrome oxide green, at least one blue pigment, such as Prussian blue and cobalt blue, and at least one white pigment, such as titanium dioxide and zinc oxide.

The color reflection layer 220 may include a base resin and a pigment dispersed in the base resin. The base resin may be an acrylic resin. And, the pigment may have a size of more than 500 nm. If the size of the pigment is less than 500 nm, light may not be reflected but instead refracted and transmitted, and thus the pigment may not perform the function of the color reflection layer 220.

The color conversion layer 190 may be converted to a transparent state or a black state by an electric field applied between the first electrode 160 and a second electrode 210 and may include an electrochromic compound or a reverse-emulsion based electrophoretic display (REED) compound.

The electrochromic compound shows differences in the rate of oxidation and reduction reactions according to the applied voltage, and the transparency may thereby be controlled. Accordingly, it may be possible to display an image by controlling the voltage applied to each pixel.

The electrochromic compound may include at least one inorganic compound, such as tungsten oxide (WO₃), molybdenum oxide (MoO₃), and iridium oxide (IrOₓ). Moreover, the electrochromic compound may include at least one organic compound, such as viologen, rare-earth phthalocyanine, and styryl. Further, the electrochromic compound may include at least one conductive polymer, such as polypyrrole, polythiophene, and polyaniline. Such electrochromic compounds may display black and white by including a plurality of materials or by increasing the color saturation.

The REED compound may include a nonpolar solvent and a polar emulsion dispersed in the nonpolar solvent. When an electric field is applied in a state where the polar emulsion is dispersed in the nonpolar solvent and thus displayed as black and white, the polar emulsion is polarized and aligned and, as a result, the transparency changes to a transparent state.

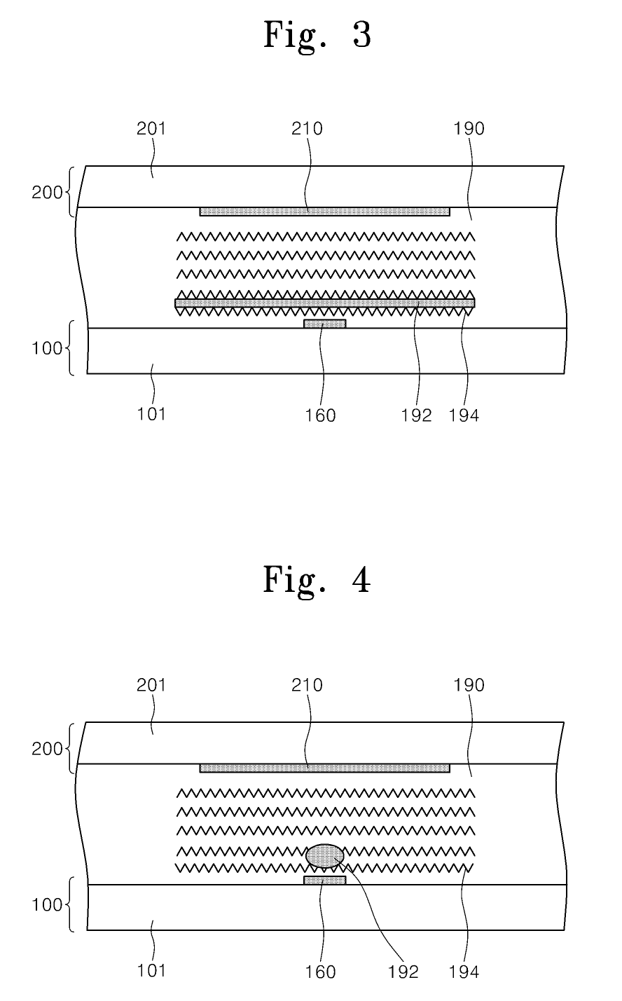

The nonpolar solvent 194, as shown in FIG. 3 and FIG. 4, may include at least one compound, such as C1-C30 alkane, C2-C30 alkene, C3-C30 alkyne, C3-C30 aldehyde, C3-C30 ketone, C2-C30 ether, C2-C30 ester, C3-C30 thioester, terpene, C2-C30 organosilane, and C2-C30 organosiloxane.

The polar emulsion 192, as shown in FIG. 3 and FIG. 4, may include at least one compound, such as alcohol, amine, amide, ketone, carboxylic acid, carboxylic acid salt, glycol, polyether, sulfide, sulfonic acid, sulfonic acid salt, sulfate, phosphide, phosphite, phosphonite, phosphinite, phosphate, phosphonate, phosphinate, imide, nitrile, isonitrile, amidine, nitro compound, nitroso compound, sulfoxide, sulfonate, thiol, and water.

In particular, the polar emulsion 192 may include at least one compound, such as dimethyl sulfoxide (DMSO), dimethylformamide (DMF), amide, methanol, ethanol, glycol, nitromethane, acetonitrile, water, methoxyethanol, methyl cellosolve, and monoethyl.

According to the present exemplary embodiment, since the color reflection layer 220 is a single layer, the transmittance may be increased.

The second substrate 200 includes a second insulating substrate 201 and the second electrode 210.

The second insulating substrate 201 may be made of an insulating material, such as glass or plastic, like the first insulating substrate 101. In this case, the second insulating substrate 201 may be made of plastic having flexibility.

The second electrode 210 may be made of a transparent conductive material and may be disposed on the entire surface of the second insulating substrate 201. For example, the second electrode 210 may be made of the same material as the first electrode 160, such as ITO, IZO, and CNT. Moreover, the second electrode 210 forms an electric field together with the first electrode 160 to control the transparency of the color conversion layer 190.

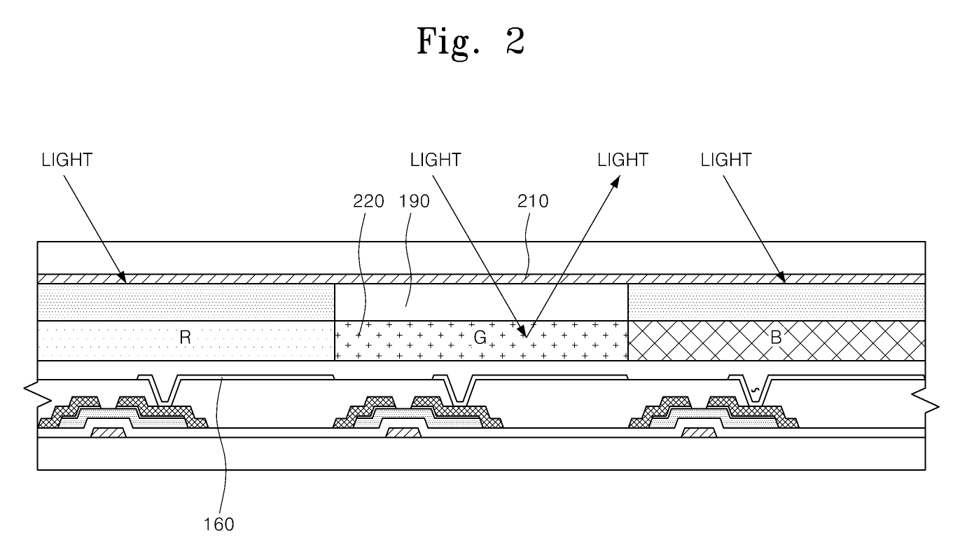

FIG. 2 is a cross-sectional view showing a process in which the color display device according to an exemplary embodiment of the present invention displays color. FIG. 2 shows that an electric field is formed between the first electrode 160 and the second electrode 210 of a green sub-pixel region G among red, green, and blue sub-pixel regions R, G, and B.

When an electric field is formed between the first and second electrodes 160 and 210 of the green sub-pixel region G, an oxidation-reduction or polarization reaction occurs in the color conversion layer 190 containing the electrochromic compound, and thus the color conversion layer 190 in the green sub-pixel region G changes to a transparent state. At this time, the red and blue sub-pixel regions R and B maintain a black state. Light incident from the outside passes through the color conversion layer 190 in the green sub-pixel region G in a transparent state and is reflected on the green color reflection layer 220, and thus the green color is displayed.

In the above exemplary embodiment, the description has been given for the case where, if an electric field is not applied, the black state is maintained, and if an electric field is applied, the transparency changes to a transparent state; however, to the contrary, the color display device of exemplary embodiments of the present invention may be configured so that, if an electric field is not applied, the transparent state is maintained, and if an electric field is applied, the transparency changes to the black state.

Next, a process, in which color is displayed when a REED compound is used in the color conversion layer of the display device according to the above exemplary embodiment of the present invention, will be described with reference to FIG. 3 and FIG. 4. FIG. 3 shows a state where an electric field is not applied to the display device, and FIG. 4 shows a state where an electric field is applied to the display device.

For convenience of description, the process of displaying black and white without a color filter will be described in brief. Moreover, the same elements as those of the previous exemplary embodiment have the same reference numerals and their description will be omitted or simplified.

Referring to FIG. 3, the display device including the REED compound includes the first substrate 100 having the first electrode 160, the second substrate 200 having the second electrode 210, and the color conversion layer 190 interposed between the two substrates 100 and 200.

The color conversion layer 190 includes the REED compound composed of the nonpolar solvent 194 and the polar emulsion 192 dispersed in the nonpolar solvent 194. The nonpolar solvent 194 may be in a transparent state, and the polar emulsion 192 may include a dye to be black or colored. As the dye, any suitable material may be used.

Since the nonpolar solvent 194 and the polar emulsion 192 dispersed in the nonpolar solvent 194, constituting the REED compound, are the same as the above-described materials, a repeated description is omitted.

When an electric field is not applied, the color conversion layer 190 including the REED compound displays black in the display device, since the polar emulsion 192 is dispersed in the nonpolar solvent 194.

Since elements other than the color conversion layer 190 including the REED compound are the same as those of the above exemplary embodiment, their detailed description will be omitted.

Referring to FIG. 4, when the electric field is formed between the first and second electrodes 160 and 210 of the display device, the polar emulsion 192 is locally focused on the top of the first electrode 160 by the polarization reaction in the color conversion layer 190 including the REED compound. Accordingly, the incident light passes through the nonpolar solvent 194 in a transparent state and is reflected, and thus the display device displays white.

In the above exemplary embodiment, the description has been given for the case where, if an electric field is not applied, the black state is maintained, and if an electric field is applied, the transparency changes to a transparent state; however, to the contrary, the color display device of exemplary embodiments of the present invention may be configured so that, if an electric field is not applied, the transparent state is maintained, and if an electric field is applied, the transparency changes to the black state. Moreover, it may be possible to display color, as well as black and white, by further applying a color filter or color conversion layer.

Furthermore, although a description has been given for the case where the color conversion layer includes the electrochromic compound or the REED compound, the present invention is not limited thereto. Rather, any compound in which the light absorption rate can be adjusted based on an applied voltage may be applied to the color conversion layer without limitation.

As described above, the color display device according to exemplary embodiments of the present invention may realize a full color display with a single thin film transistor substrate using a black color conversion layer. Accordingly, it may be possible to significantly simplify the manufacturing process, reduce manufacturing costs, and obtain a slim display device.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A color display device, comprising:
a first substrate divided into a plurality of sub-pixel regions, the first substrate comprising a thin film transistor comprising a first electrode;
a second substrate facing the first substrate, the second substrate comprising a second electrode to form an electric field together with the first electrode;
a color reflection layer disposed between the first substrate and the second substrate to reflect incident light; and
a color conversion layer disposed on the color reflection layer.

2. The color display device of claim 1, wherein the color conversion layer is a single layer.

3. The color display device of claim 1, wherein the color conversion layer changes to a transparent state or a black state when an electric field is applied between the first electrode and the second electrode.

4. The color display device of claim 1, wherein the color conversion layer comprises an electrochromic compound.

5. The color display device of claim 4, wherein the electrochromic compound comprises at least one inorganic compound selected from the group consisting of tungsten oxide (WO₃), molybdenum oxide (MoO₃), and iridium oxide (IrOₓ).

6. The color display device of claim 4, wherein the electrochromic compound comprises at least one organic compound selected from the group consisting of viologen, rare-earth phthalocyanine, and styryl.

7. The color display device of claim 4, wherein the electrochromic compound comprises at least one conductive polymer selected from the group consisting of polypyrrole, polythiophene, and polyaniline.

8. The color display device of claim 3, wherein the color conversion layer comprises a reverse-emulsion based electrophoretic display (“REED”) compound.

9. The color display device of claim 8, wherein the REED compound comprises a nonpolar solvent and a polar emulsion dispersed in the nonpolar solvent.

10. The color display device of claim 9, wherein the nonpolar solvent comprises at least one compound selected from the group consisting of C1-C30 alkane, C2-C30 alkene, C3-C30 alkyne, C3-C30 aldehyde, C3-C30 ketone, C2-C30 ether, C2-C30 ester, C3-C30 thioester, terpene, C2-C30 organosilane, and C2-C30 organosiloxane.

11. The color display device of claim 9, wherein the polar emulsion comprises at least one compound selected from the group consisting of alcohol, amine, amide, ketone, carboxylic acid, carboxylic acid salt, glycol, polyether, sulfide, sulfonic acid, sulfonic acid salt, sulfate, phosphide, phosphite, phosphonite, phosphinite, phosphate, phosphonate, phosphinate, imide, nitrile, isonitrile, amidine, nitro compound, nitroso compound, sulfoxide, sulfonate, thiol, and water.

12. The color display device of claim 1, wherein the color reflection layer comprises a pigment or dye.

13. The color display device of claim 12, wherein the color reflection layer comprises a base resin and a pigment dispersed in the base resin.

14. The color display device of claim 13, wherein the base resin is an acrylic resin.

15. The color display device of claim 14, wherein the pigment has a size of more than 500 nm.

16. The color display device of claim 12, wherein the color reflection layer comprises at least one layer selected from the group consisting of a red color reflection layer, a green color reflection layer, and a blue color reflection layer.

17. The color display device of claim 16, wherein the color reflection layer further comprises a white color reflection layer.

18. The color display device of claim 16, wherein the color reflection layer comprises at least one red pigment selected from the group consisting of bengala, vermilion, and cadmium red.

19. The color display device of claim 16, wherein the color reflection layer comprises at least one green pigment selected from the group consisting of emerald green and chrome oxide green.

20. The color display device of claim 16, wherein the color reflection layer comprises at least one blue pigment selected from the group consisting of Prussian blue and cobalt blue.

21. The color display device of claim 17, wherein the color reflection layer comprises at least one white pigment selected from the group consisting of titanium dioxide and zinc oxide.
